(19) United States
(12) Patent Application Publication
(10) Pub. No.: US 2014/0326320 A1
(43) Pub. Date: Nov. 6, 2014

(54) COLD GAS GENERATOR FOR PROVIDING COLD GAS FOR ACTIVATING AN AIR BAG AND METHOD FOR PROVIDING COLD GAS FOR ACTIVATING AN AIR BAG

(71) Applicant: Monika Nitschke, Asperg (DE)

(72) Inventors: Matthias Marcus Wellhoefer, Stuttgart (DE); Werner Nitschke, Asperg (DE)

(21) Appl. No.: 14/236,761

(22) PCT Filed: Jun. 4, 2012
(86) PCT No.: PCT/EP2012/060482

§ 371 Date: Apr. 23, 2014

(30) Foreign Application Priority Data
Aug. 3, 2011 (DE) 10 2011 080 342.4

(51) Int. Cl. B60R 21/268

(52) U.S. Cl. CPC B60R 21/268; B60R 2021/26017
USPC 137/1; 137/223

(57) ABSTRACT

A cold gas generator for providing cold gas for an activation of an air bag, the cold gas generator having a cold gas outlet for connection to the air bag, a first volume for a first cold gas, a first connecting device, a second volume for a second cold gas and a second connecting device. The first connecting device is developed to connect the first volume to the cold gas outlet, in response to a first activating pulse. The second connecting device is developed to connect the second volume to the cold gas outlet or to the first volume.

### FIELD

The present invention relates to a cold gas generator for providing cold gas for activating an air bag, for instance, an air bag of a vehicle, and to a method for providing cold gas for activating an air bag.

### BACKGROUND INFORMATION

A conventional air bag is inflated at least partially by the reaction gas of a rapid chemical reaction. For this purpose, a propellant charge is ignited and burned. In order to lower the temperature of the reaction gas and to lower an inflation speed of the air bag, a pressure vessel may additionally be opened by the ignition of the propellant charge, so that a compressed gas contained in it is able to flow at a predetermined volume flow from out of the pressure vessel and also into the air bag.

### SUMMARY

The present invention provides a cold gas generator for providing cold gas for activating an air bag and a method for providing cold gas for activating an air bag according to the main claims. Advantageous refinements are derived from the description below.

Air bag gas generators are installed in many vehicles. Usually, so-called pyrotechnical gas generators or hybrid gas generators are involved, which include an explosive in the form of a solid chemical. This chemical is ignited by a firing pellet. A large quantity of hot gas is generated by an exothermic reaction of the solid chemical, which directly inflates the air bag as hot gas. In the hybrid gas generator, the solid chemical represents a first step of blowing against the air bag using the hot gas, for one, and at the same time opening an additional cold gas vessel using the explosive.

Pure cold gas generators have a single pressure vessel which is filled with a gas, such as nitrogen or helium, under high inlet pressure of ca. 500-1200 bar. The gas is able to flow into the air bag via a valve or an outlet opening.

For driver air bags and front passenger air bags, but also increasingly for side air bags, a multi-stage air bag may be used. This means that the explosive is subdivided into a plurality of units and the ignition of the explosive is able to take place in several steps. Higher steps, depending on the type of crash may also be suppressed. For example, in a front LRD (low risk deployment) only the first step may be activated, and the air bag inflates, for example, to only 60% of its maximum volume. Thereby protection may be achieved of the 5% women or for children on the front-passenger seat.

A cold gas generator may most simply and cost-optimized be implemented in a multi-stage manner, and may do without explosive. When explosive is used, problems arise again and again, because of explosives laws, in the import and export of air bags into and from other regions. However, because of multi-stage properties, front air bags are still typically embodied pyrotechnically or as hybrid generators. In the approach presented here, although no explosive for providing hot gas for inflating an air bag is installed, for front air bag modules a multi-stage property and adaptiveness may nevertheless be implemented. Considerable costs may be saved, or improved safety. Under certain circumstances, an explosive or a material generating heat may be used for opening a cold gas vessel. In this context, however, negligibly small quantities of gas are generated in comparison to the quantity of cold gas.

Consequently, the present invention is based on the recognition that one may embody a gas generator for an air bag without using a pyrotechnical propellant charge. To do this, a pressure vessel may be closed air-tight in a state of readiness, using a seal. When the air bag is activated, the seal of the pressure vessel may be opened by an activating pulse. The gas may then flow from the pressure vessel into the air bag. The pressure vessel may be subdivided or divided up into a plurality of vessels, which may be connected to the air bag via a collector. When using a plurality of vessels, the air bag may be activated in several steps. Thus, inflating the air bag may be adapted to different situations. The air bag may also remain in the inflated state for a longer time period if a plurality of vessels are not opened simultaneously, but one after the other.

The present invention provides an example cold gas generator for providing cold gas for activating an air bag, the cold gas generator having the following features:

a cold gas outlet for connecting to the air bag;

a first volume for a first cold gas;

a first connecting device which is able to connect the first volume to the cold gas outlet, in response to a first activating pulse;

a second volume for a second cold gas; and

a second connecting device which is developed to connect the second volume to the cold gas outlet or the first volume.

The air bag may be used in a vehicle, in order to protect a passenger of the vehicle during an accident of the vehicle. The air bag may be a cushion able to be filled with gas, that is capable of absorbing energy, which, when necessary, is able to be filled with the gas during the accident. Before the accident, the air bag may be emptied and packaged in a state of readiness. By a cold gas generator one may understand a gas storage for an air bag, that is developed to have the gas for activating the air bag ready, and to provide it if necessary. A cold gas outlet may be a connection for the air bag, via which the gas is able to flow into the air bag, in order to inflate the air bag. The cold gas outlet may have an antechamber or mixing chamber for homogenizing a gas flow through the cold gas outlet. A first volume may be a first chamber for compressed gas. A second volume may be a second chamber for compressed gas. The volumes may of different sizes. The volumes may be designed for different internal pressures. The volumes may be prepared to have ready different gases. The first gas may also be the same as the second. The volumes may have a common separating wall, or may be situated at a distance from each other. The first connecting device may be impervious to gas in the ready state, in order to keep the volume closed in a gas-tight manner. In response to the activating pulse, the first connecting device may be made impervious to gas or may be opened in order to enable the exit of the first gas from the first volume. The first connecting device may be situated between the cold gas outlet and the first volume. The activating pulse may, for instance, be an electrical pulse, a thermal pulse of a mechanical pulse which is suitable for opening the connecting device at least partially, that is, to make it permeable to gas. The activating pulse may be provided controlled by a control unit, which includes an accident sensor system or is connected to an accident sensor system. The first connecting device may be executed as a diaphragm, a valve or another type of closure. The second connecting device may be impervious to gas in the ready state, in order to keep the volume closed in a gas-tight manner. In response to the, or to an additional activating pulse, the second connecting device may become permeable to gas, or open, in order to enable an exit of the second gas from the second volume, or directly to the cold gas outlet. Alternatively, the second connecting device may be implemented as a constantly at least partially opened connection between the first volume and the second volume.

The second connecting device may be a throttle, which is developed to connect the second volume to the first volume in a manner permeable to gas. By a throttle one may understand an opening having a specified cross section of passage. A cross section of passage of the throttle may be selected so that the second gas from the second volume is able to flow through the throttle into the first volume more slowly than the gas from the first volume is able to flow into the air bag. The cross section of passage of the throttle may, for instance, be smaller than a cross section of passage of the outlet opening. Because of the throttle, the same pressure may prevail in both volumes before the activation of the first connecting device. After the activation of the first connecting device, until the setting of a renewed pressure equalization, a lower pressure is able to prevail in the first volume than in the second volume. Because of the throttle, gas from the second volume may continuously flow after into the air bag, in order to keep the air bag in an inflated state.

The second connecting device may be developed to connect the two volumes, in response to a predetermined pressure difference between the second volume and the first volume. In the ready state, the second connecting device may be closed and may limit the second volume from the first volume in a gas-tight manner. The second connecting device may be developed to become permeable to gas, when reaching a pressure difference between the pressure in the second volume and the pressure in the first volume, in order to become permeable to gas, for instance, by breaking. Thereupon the gas from the second volume may flow after from the second volume through the second connecting device, that has become permeable to gas, into the first volume, throttled or unthrottled by the throttle. The pressure difference may be selected so that between a time of activation of the first connecting device and a time of the opening of the second connecting device there is a predetermined time span.

The second connecting device may be developed, in response to a second activating pulse, to connect the second volume to the cold gas outlet. Alternatively or in addition, the second connecting device may be developed, in response to a second activating pulse, to connect the second volume to the cold gas outlet. Because of the second activating pulse, a point in time of the utilization of the second gas that is stored in the second volume may be freely selected. Thus, the triggering behavior of the air bag may be adapted to an accident situation.

The cold gas generator may have an activating device, which is developed to provide at least the first activating pulse, in response to an activating signal. The activating device is able to provide an activating energy for activating the connecting device. The activating device may be developed to provide the electrical pulse, the thermal pulse or the mechanical pulse for activating the connecting device. An activating signal may be an electrical signal that is able to be received by a control of the air bag.

The activating unit may be developed to provide the second activating pulse in response to a further activating pulse.

Thereby, using one activating unit, the respectively required activating energy may be provided successively in time, for different connecting devices. The second activating pulse may, for example, differ with respect to its intensity or effective duration in time from the first activating pulse.

The cold gas generator may have a further activating device, which is developed to provide the second activating pulse, in response to the further activating signal. Using a further activating unit, the second activating pulse may be provided if the connecting devices are situated at a greater distance from each other.

The cold gas generator may have at least one additional cold gas outlet and at least one further connecting device. The further connecting device may be developed, in response to an additional activating pulse, to connect one of the volumes to the additional cold gas outlet. By an additional cold gas outlet one may understand a bypass into the environment of the cold gas generator, which is developed to let gas from the first volume or from the second volume flow unused into the environment. The air bag may thereby be set less hard, in order for it to be able to cushion lighter objects in an improved manner. The additional cold gas outlet may have a specified flow cross section, whereby it is able to act as a throttle.

The first volume is able to be filled with the first cold gas under a first pressure. The second volume is able to be filled with the second cold gas under a second pressure. Using different gases, pressures and volumes, the gas generator may be designed for various situations, for instance, for different air bags or for different air bag applications.

The cold gas generator may have additional volumes which are connected via additional connecting devices to the cold gas outlet or to other volumes. If it has a plurality of volumes having sizes and pressures according to demand, the air bag may be kept inflated over a longer time span for absorbing impact energy. This may be required, for instance, if a body part is slung into the air bag only in response to a secondary acceleration of an accident.

The present invention further provides a method for providing cold gas for an air bag activation, the method including the following steps:

connecting a first volume for a first cold gas to a cold gas outlet for connecting to the air bag, in response to a first activating pulse; and

connecting a second volume for a second cold gas to the cold gas outlet or the first volume.

The method may include additional steps of connecting, in order to enable an improved adaptation of the air bag to the accident conditions. The method is able to be carried out in each case in an adapted fashion, in order to operate a cold gas generator according to different specific embodiments of the present invention.

Below, the present invention is explained in greater detail with reference to the figures.

### BRIEF DESCRIPTION OF THE DRAWINGS

FIG. 1 shows an illustration of a cold gas generator according to an exemplary embodiment of the present invention, having two activating devices.

FIG. 2 shows an illustration of a cold gas generator according to an exemplary embodiment of the present invention, having one activating device.

FIG. 3 shows an illustration of a cold gas generator according to a further exemplary embodiment of the present invention, having one activating device.

FIG. 4 shows an illustration of a cold gas generator according to an exemplary embodiment of the present invention, having one activating device and a bypass.

FIG. 5 shows an illustration of a cold gas generator according to an exemplary embodiment of the present invention, having one activating device and a throttle that is able to be activated.

FIG. 6 shows an illustration of a cold gas generator according to an exemplary embodiment of the present invention, having one activating device and a throttle.

FIG. 7 shows a flow chart of a method for providing cold gas for an air bag activation according to an exemplary embodiment of the present invention.

FIG. 8 shows a vehicle having a cold gas generator according to an exemplary embodiment of the present invention.

### DETAILED DESCRIPTION OF EXAMPLE EMBODIMENTS

In the subsequent description of preferred exemplary embodiments of the present invention, the same or similar reference numerals are used for the elements that are shown in the various figures and act similarly, a repeated description of these elements having been dispensed with.

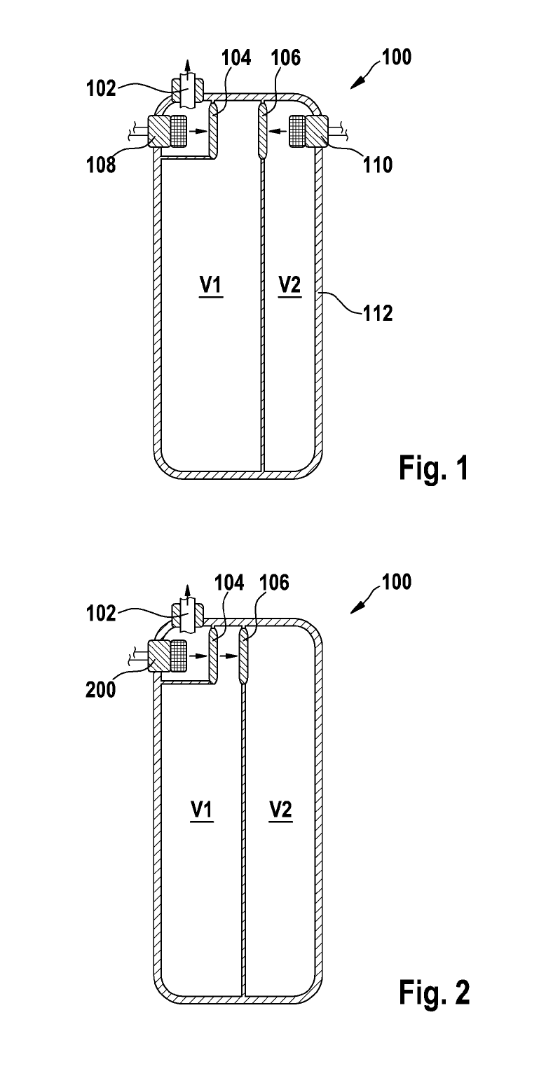

FIG. 1 shows an illustration of a cold gas generator 100 according to an exemplary embodiment of the present invention. The cold gas generator has a cold gas outlet 102, a first volume V1, a first connecting device 104, a second volume V2, a second connecting device 106, a first activating device 108 as well as a second activating device 110.

The first volume V1, the second volume V2 as well as an antechamber of cold gas outlet 102 are situated within a pressure vessel 112. The antechamber is separated from first volume V1 by a first separating wall. First volume V1 is separated from second volume V2 by a second separating wall. First volume V1 is greater than second volume V2.

First activating device 108 is situated on an area of the wall of pressure vessel 112, lying within the antechamber, and is developed to provide a first activating pulse, in response to a first activating signal. Connection terminals of first activating device 108 are passed through the wall of pressure vessel 112, so that the activating signal is able to be provided to first activating device 108 from outside pressure vessel 112. First connecting device 104 is situated in the first separating wall, lying opposite to first activating device 108. First connecting device 104 is developed to connect first volume V1 to cold gas outlet 102, in response to the first activating pulse of first activating device 108.

Second activating device 110 is situated on an area of the wall of pressure vessel 112, lying within second volume V2, and is developed to provide a second activating pulse, in response to a second activating signal. Connection terminals of second activating device 110 are passed through the wall of pressure vessel 112, so that the activating signal is able to be provided to first activating device 110 from outside pressure vessel 112. Second connecting device 106 is situated in the second separating wall, lying opposite to second activating device 110. Second connecting device 106 is developed to connect second volume V2 to first volume V1 in response to the second activating pulse.

In this exemplary embodiment, an activating pulse is provided by each of the first activating device 108 and the second activating device 110, when the respective activating devices 108, 110 receive an activating signal.

Alternatively, only one single activating device may be provided, which is developed to provide both the first activating pulse and the second activating pulse. In this instance, the activating device may be situated in first volume V1 between first connecting device 104 and second connecting device 106, for example. The single connecting device may be developed to provide the first activating pulse in response to receiving the first activating signal and the second activating pulse in response to receiving the second activating signal. Furthermore, the single activating device may be developed to provide the first activating pulse and the second activating pulse simultaneously, in response to a single activating signal.

In the following, with the aid of FIG. 1, a multi-stage, here a 2-stage cold gas module 100 is described, according to an exemplary embodiment of the present invention. According to this exemplary embodiment, the activating devices 108, 110 are designed as ignition elements or firing pellets, and connecting devices 104, 106 as diaphragms, for instance, as metal diaphragms.

Cold gas module 100 has a plurality, two here, of ignition elements 108, 110 which, when activated by a standard ignition pulse, heat and soften up respective diaphragm 104, 106, so that the overpressure prevailing in each case on one side of the diaphragm leads to a breakthrough in the respective diaphragm 104, 106, and the pressure is able to escape from first volume V1 and possibly from second volume V2 via outlet opening 102. In this context, upon ignition of only one step, only pressure volume V1 is able to be opened. Because of second ignition step 110, volume V2 may be connected in before the ignition of V1, whereby a pressure equalization comes about between volume V1 and volume V2, before the cold gas escapes through outlet opening 102. Alternatively, an adaptive pressure adjustment is able to take place by opening or connecting volume V2 after opening volume V1, that is, during the outflow process of the first gas from volume V1. The pressure in volume V1, at closed diaphragms 104, 106, may be larger, smaller or equal to the pressure in volume V2. Correspondingly different controls may be implemented thereby.

FIG. 2 shows an illustration of a cold gas generator 100 according to an exemplary embodiment of the present invention. Cold gas generator 100 is constructed generally corresponding to the cold gas generator in FIG. 1. By contrast to the cold gas generator in FIG. 1, cold gas generator 100 has only a single activating device 200. Moreover, volume V1 is equal to volume V2. Activating device 200 is situated in the antechamber, corresponding to the first activating device in FIG. 1. First connecting device 104 and second connecting device 106 are situated parallel to each other, at a small distance from each other, one behind the other, and on each other as well as opposite activating device 200. Activating device 200, first connecting device 104 and second connecting device 106 are situated at the same height of the pressure vessel, along a line. Second connecting device 106 is at a greater distance than first connecting device 104 from activating device 200. Second connecting device 106 is situated behind first connecting device 104, with reference to activating device 200. To activate second connecting device 106, the second activating pulse passes the already opened first connecting device 104.

According to one exemplary embodiment, activating device 200 is developed to provide the first activating pulse for opening first connecting device 104 in response to receiving a first activating signal and a second activating pulse for opening second connecting device 106 in response to receiving a second activating signal.

According to one alternative exemplary embodiment, activating device 200 is developed to provide the first activating pulse and the second activating pulse as separate pulses or as an in-common pulse, simultaneously in response to the single activating signal.

In the following, with the aid of FIG. 2, a multi-stage, here a 2-stage cold gas module 100 is described, according to an exemplary embodiment of the present invention. Cold gas module 100 has only one multifunctional ignition step 200. Using a short actuation of ignition step 200, only the first diaphragm 104 is opened, so that gas volume V1 is able to escape through the outlet opening having an associated pressure P1. At a later time, during the inflating of the air bag, by gas volume V1 and using the same ignition step 200, the next, here the second metal diaphragm 106 may be opened, that is, a multi-ignition takes place, so that volume V2 having a pressure P2 is connected during the outflow process.

Alternatively, by a stronger or longer ignition pulse at firing pellet 200, using one pulse, the two or more metal diaphragms 104, 106 may immediately be opened, so that the two volumes V1 and V2 are instantaneously connected together. Thereby a pressure equalization is created between pressures P1, P2 if the cold gas gets into the air bag through outflow opening 102. As a design variant, second diaphragm 106, or generally, the nth diaphragm in a number of n adjacent volumes separated by n diaphragms, may break by itself automatically in response to a certain differential pressure or open as a throttle.

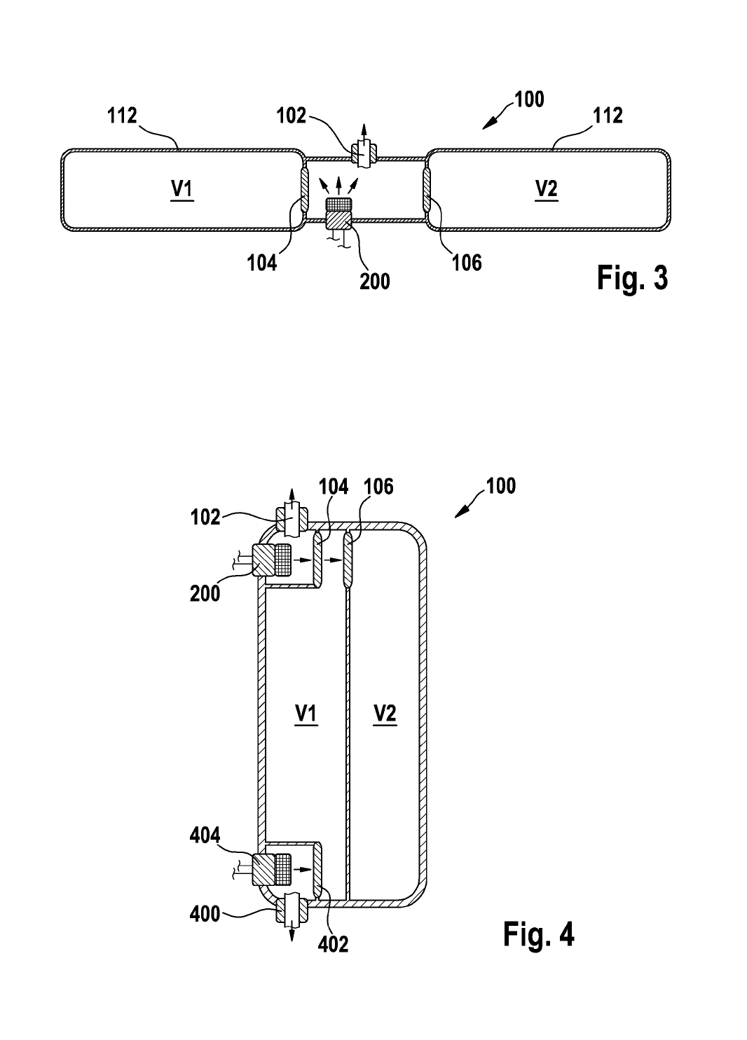

FIG. 3 shows an illustration of a cold gas generator 100 according to an exemplary embodiment of the present invention. Cold gas generator 100, the same as the cold gas generators in FIGS. 1 and 2, has a first volume V1 and a second volume V2. By contrast to FIGS. 1 and 2, volumes V1 and V2 are each situated in a separate pressure vessel 112. The two pressure vessels 112 are situated on opposite sides of the antechamber including outlet opening 102. In the working position, first volume V1 is closed by first connecting device 104 and second volume V2 is closed by second connecting device 106 in a gas-tight manner with respect to the antechamber. In the antechamber, an activating device 200 is situated, which is developed to provide a first activating pulse for opening first connecting device 104 in response to receiving a first activating signal and a second activating pulse for opening second connecting device 106 in response to receiving a second activating signal. According to this exemplary embodiment, activating device 200 is situated closer to first connecting device 104 than to second connecting device 106. Based on the different distances, it is true that the first activating pulse is able to have the effect of opening first connecting device 104, but not of opening second connecting device 106. To open second connecting device 106, activating device 200 may be developed to execute the second activating pulse more forcefully or longer in time than the first activating pulse. If two connecting devices 104, 106, as for instance in this exemplary embodiment, are opened by one single activating device 200, connecting device 106 that is to be opened at a later time is able to be designed in a more stable manner than connecting device 104 that is to be opened at an earlier time. Alternatively, connecting devices 104, 106 may be designed the same, and by a situation or an alignment of activating device 200 it may be ensured that, by the first activating pulse, only the first of connecting devices 104, 106 is opened.

Activating device 200 may also be developed to provide the first activating pulse and the second activating pulse simultaneously, in response to a single activating signal. In this context, the first activating pulse and the second activating pulse may be regarded as partial pulses of a single activating pulse.

In the following, with the aid of FIG. 3, a multi-stage, here a 2-stage cold gas module 100 is described, according to an exemplary embodiment of the present invention. Cold gas module 100 is implemented in a T-shaped arrangement of two separate pressure volumes V1 and V2, having a central connection by a pressure outlet 102 and a multifunctional firing pellet 200. Firing pellet 200 is developed only to open left diaphragm 104 of volume V1, using a simple and/or short ignition pulse. Furthermore, firing pellet 200 is developed also to connect to, simultaneously or later, volume V2 by using a longer pulse or a second pulse.

FIG. 4 shows an illustration of a cold gas generator 100 according to an exemplary embodiment of the present invention. Cold gas generator 100 is constructed generally corresponding to the cold gas generator in FIG. 2. In addition to the cold gas generator in FIG. 2, cold gas generator 100 shown in FIG. 4 has an additional cold gas outlet 400. A further connecting device 402 is situated in an additional separating wall between an additional antechamber of the additional cold gas outlet 400 and first volume V1. Further connecting device 402 is developed to connect first volume V1 to the additional antechamber, in response to an additional activating pulse. In the additional antechamber, a further activating unit 404 is situated, which is developed to provide the further activating pulse, in response to the further activating signal.

In other words, FIG. 4 shows a multi-stage, here a 2-stage cold gas module 100, as is described in FIG. 2, however, having an additional bypass 400 outwards in volume V1.

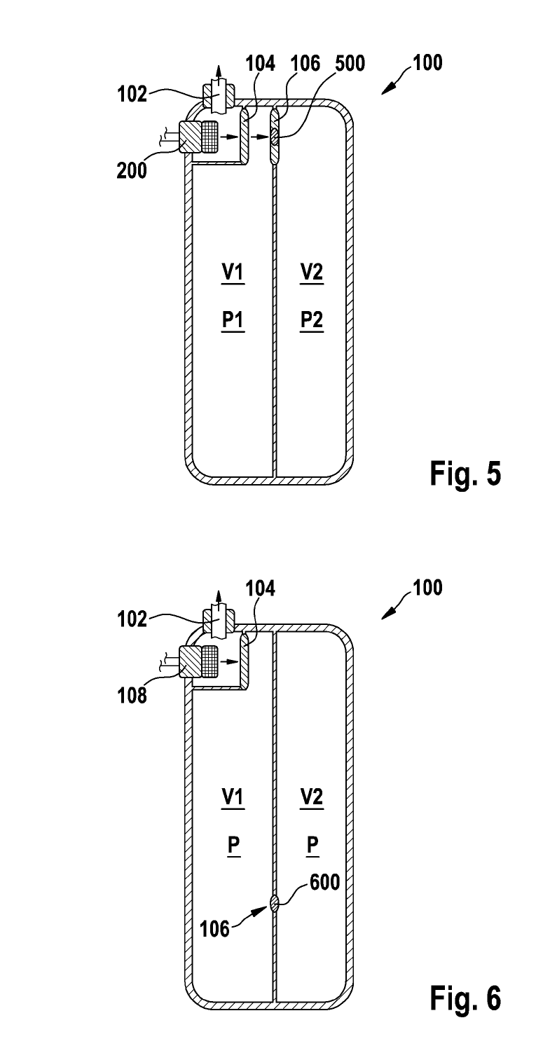

FIG. 5 shows an illustration of a cold gas generator 100 according to an exemplary embodiment of the present invention. Cold gas generator 100 is constructed generally corresponding to the cold gas generator in FIG. 2. In contrast to FIG. 2, cold gas generator 100 shown in FIG. 5 has an activatable throttle 500 in second connecting device 106. Second connecting device 106 is developed to connect second volume V2 to first volume V1 via a specified flow cross section of throttle 500, in response to an activating pulse of activating device 200. In the ready state, throttle 500 is held closed by connecting device 106, so that in volume V1 a first pressure P1 and in second volume V2 a pressure P2 differing from pressure P1 is able to prevail. After the opening of throttle 500, pressures P1 and P2 are able to become equalized. Alternatively, pressure P1 and pressure P2 are able to be equal in the ready state.

In other words, FIG. 5 shows a multi-stage, here a 2-stage cold gas module 100, having an activatable throttle 500. Based on activatable throttle 500, volumes V1, V2 may have different pressures P1, P2.

FIG. 6 shows an illustration of a cold gas generator 100 according to an exemplary embodiment of the present invention. Cold gas generator 100, as in FIG. 1, has a cold gas outlet 102, a first volume V1, a first connecting device 104, a second volume V2, a second connecting device 106, a first activating device 108. Activating device 108 and first connecting device 104 are designed and situated corresponding to the cold gas generator described with reference to FIG. 1.

Second connecting device 106 differs from second connecting device 106 described with reference to FIG. 1. According to this specific embodiment, second connecting device 106 is designed as a fixed throttle 600. Fixed throttle 600 already has a gas-permeable opening in the ready state. First volume V1 is equal to second volume V2. In both volumes in the ready state, because of fixed throttle 600 the same pressure P prevails. When first activating device 108 activates first connecting device 104, the cold gas flows from first volume V1 through cold gas outlet 102 into the air bag, and a pressure difference is created between first volume V1 and second volume V2. Because of throttle 600 having the fixed flow cross section, based on the pressure difference, the cold gas is able to stream after from second volume V2.

In other words, FIG. 6 shows a multi-stage, here a 2-stage cold gas module 100, having a fixed throttle 600. Based on fixed throttle 600, volumes V1, V2 have a uniform pressure P in the ready state.

To sum up, FIGS. 1 through 6 show different implementations of multi-stage cold gas generators 100. Cold gas reactors 100 are designed as simply as possible, but they still supply multi-stage properties and an adaptive inflation behavior.

The execution of the abovementioned cold gas modules 100 relate to various possibilities of implementation. One possibility, in this context, is the utilization of separate cold gas chambers V1, V2, which are able to be connected to each other on the inside, so as to create pressure equalization of the two volumes V1, V2. The two originally separated volumes V1, V2 are situated within a common cartridge 112 and may have different pressures P1, P2. Different types of gas may also be used for the two volumes V1, V2. Separating diaphragms 104, 106 are able to break through, actively by an ignition or passively by a certain pressure difference, which is able to build up by the ignition of a stage.

The entire separating wall may also be able to be bent flexibly. The separating diaphragm that is able to break up may also include a fixed throttle 600, in order to prolong the inflating duration, for instance, and thereby also make the inflating process more passenger-friendly, as is the case with a soft air bag, for example. This throttle 600 is preferably used in the separating wall between the two chambers V1, V2. Particularly for head air bags and rollover curtains, when using multi-stage pressure chambers V1, V2, a longer residence time may be implemented, in that the leakage, based on an air or gas passage through the material and the seams of the air bag, is compensated for by the “streaming after”. Thereby, on the one hand, the long residence times required in the rollover case may be achieved, and one may do without costly siliconization of the material for sealing purposes. The design of throttle 600 between two sectional chambers V1, V2 may be implemented passively, i.e., throttle 600 is open and P1=P2, that is, the same pressure prevails on both sides of throttle 600. When outlet opening 102 to the air bag is opened, throttle 600 acts on volume V2, since outflow opening 102 to the air bag is substantially larger and V1 flows out directly, while volume V2 flows out in a throttled manner.

Alternatively, throttle 500 may also be opened actively, as described in connection with diaphragms 104, 106, so that the two participating volumes V1, V2 have different pressures P1, P2, and the point in time of the throttle opening is able to be selected freely, such as by an ignition. Besides the variant in which different pressures P1, P2 are able to prevail in the different sectional chambers V1, V2, volumes V1, V2 themselves may also be of different size. For example, a main stage V1 having two to four post-connected “little stages” may be provided, to each of which its own volume chamber is assigned. In at least one partial pressure chamber V1, V2, an additional igniter 404 may optionally open an outwardly directed opening 400 in order abruptly to reduce pressure P, by having half the gas escape through the additional opening 400 to outside the air bag. The difference in time between the opening of the air bag outlet opening 102 and the opening outwards through a bypass 400 determines the proportion of the gas quantity streaming into the air bag as well as the pressure P. In this context, either the opening of bypass 400 may occur after the opening of air bag outlet opening 102, or at the same time, and also the other way round, that is, before. Thus, a plurality of possibilities come about for designing the air bag inflation process adaptively.

The systems, forms, sizes and size relationships shown of the individual volumes V1, V2 have only been selected exemplarily, and may be adapted to the respective circumstances. Similarly, an arrangement and design of connecting devices 104, 106 as well as of activating devices 108, 110, 200, 404 are selected only in exemplary fashion and may be varied in a suitable manner.

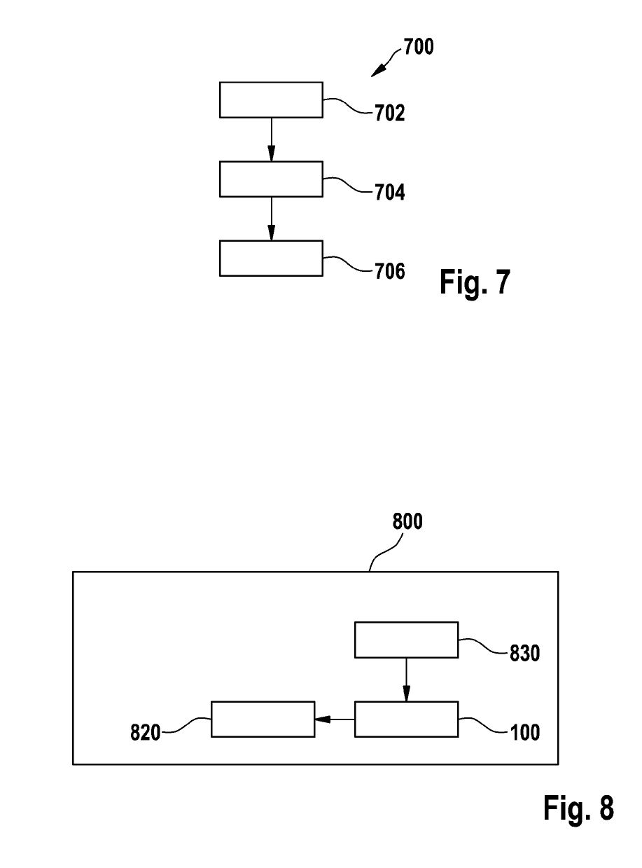

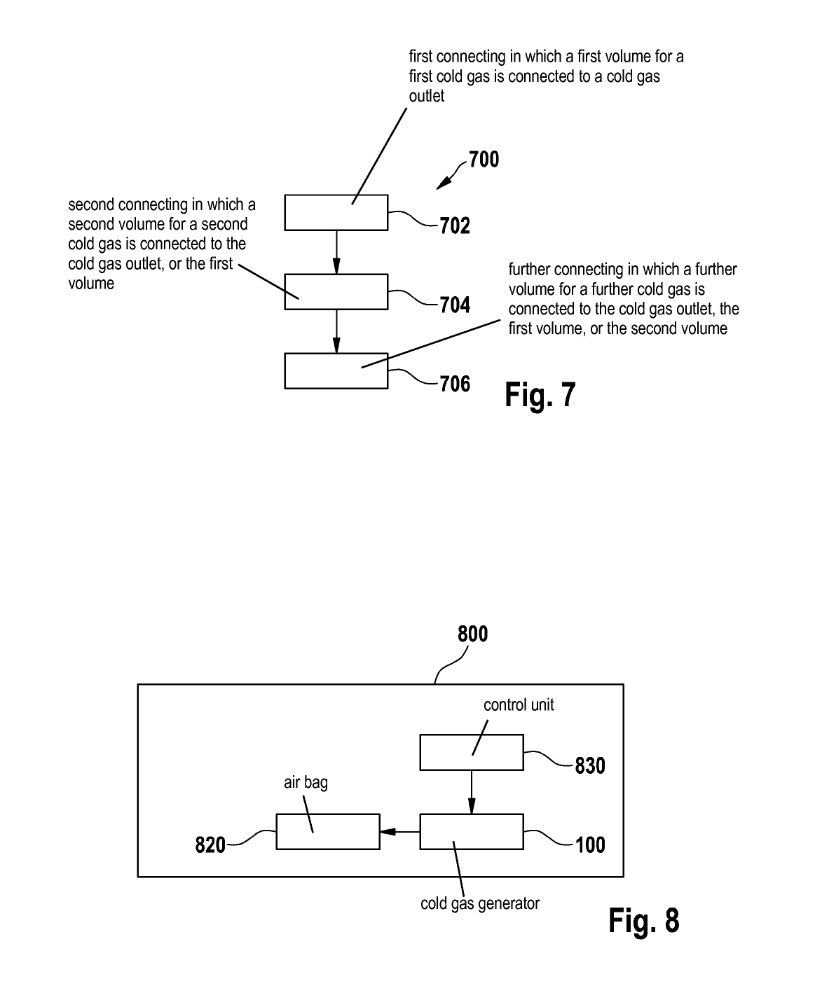

FIG. 7 shows a flow chart of a method 700 for providing cold gas for an air bag activation, according to one exemplary embodiment of the present invention. Method 700 may be used for operating a cold gas generator, as described with the aid of FIGS. 1 through 6, for example. Method 700 has a first step of connecting 702, a second step of connecting 704 and a further step of connecting 706. In the first step of connecting 702, a first volume for a first cold gas is connected to a cold gas outlet for connection to an air bag. This takes place in response to a first activating pulse. In the second step of connecting 704, a second volume for a second cold gas is connected to the cold gas outlet or the first volume. This takes place in response to a second activating pulse. In the further step of connecting 706, a further volume for a further cold gas is connected to the cold gas outlet, the first volume or the second volume. This takes place in response to a further activating pulse. A single step of connecting 702, 704, 706 is able to represent a stage of activating the air bag. By a sequence in time of the steps, the air bag may be held in a state ready for absorption, for instance, over a longer time period. By omitting individual steps, the air bag may be inflated less strongly, whereby a lighter passenger is exposed to a lower risk of injury, for example. By simultaneously carrying out at least two of the steps of connecting 702, 704, 706 by the respectively separate activating pulses or an in-common activating pulse including the respective activating pulses, the inflation of the air bag may be speeded up.

FIG. 8 shows a vehicle 800 having a cold gas generator 100 according to an exemplary embodiment of the present invention. Cold gas generator 100 may be a cold gas generator described with the aid of FIGS. 1 through 6. Cold gas generator 100 is connected to an air bag 820 via a cold gas outlet. One opening of air bag 820 may be firmly connected to the cold gas outlet for this. A control unit 830 is connected to cold gas generator 100 via an electric line, for example. Control unit 830 may be an air bag control unit, as is conventional in the automotive field for actuating air bags. Depending on the form of execution and the triggering characteristics aimed at of air bag 820, control unit 830 is developed to provide one or more activating signals to one or more activating devices of cold gas generator 100, so as to trigger one or more activating pulses, in response to which the streaming out of gas takes place through the cold gas outlet into air bag 820.

The exemplary embodiments described and shown in the figures have been selected merely as examples. Different exemplary embodiments are combinable with one another, either completely or with regard to individual features. An exemplary embodiment may also be supplemented by features from another exemplary embodiment. Furthermore, method steps according to the present invention may be carried out repeatedly and also performed in a sequence other than the one described. If an exemplary embodiment includes an “and/or” linkage between a first feature and a second feature, this may be understood to mean that the exemplary embodiment according to one specific embodiment has both the first feature and the second feature, and according to an additional specific embodiment, either has only the first feature or only the second feature.

1-10. (canceled)

11. A cold gas generator for providing cold gas for activating an air bag, comprising:
a cold gas outlet to connect to the air bag;
a first volume for a first cold gas;
a first connecting device to connect the first volume to the cold gas outlet in response to a first activating pulse;
a second volume for a second cold gas; and
a second connecting device to connect the second volume to the cold gas outlet or to the first volume.

12. The cold gas generator as recited in claim 11, wherein the second connecting device is a throttle which connects the second volume to the first volume.

13. The cold gas generator as recited in claim 11, wherein the second connecting device connects the first volume and the second volume in response to a predetermined pressure difference between the second volume and the first volume.

14. The cold gas generator as recited in claim 11, wherein the second connecting device connects the second volume to the cold gas outlet or the first volume in response to a second activating pulse.

15. The cold gas generator as recited in claim 14, further comprising:
an activating device to provide at least the first activating pulse in response to an activating signal.

16. The cold gas generator as recited in claim 15, wherein the activating device provides the second activating pulse in response to a further activating signal.

17. The cold gas generator as recited in claim 15, further comprising:
a further activating device to provide the second activating pulse in response to a further activating signal.

18. The cold gas generator as recited in claim 11, further comprising:
at least one further cold gas outlet and at least one further connecting device to connect one of the first volume and the second volume to the further cold gas outlet in response to an additional activating pulse.

19. The cold gas generator as recited in claim 11, wherein the first volume is filled with the first cold gas under a first pressure and the second volume is filled with the second cold gas under a second pressure.

20. A method for providing cold gas for an air bag activation, comprising:
connecting a first volume for a first cold gas to a cold gas outlet for connecting to the air bag in response to a first activating pulse; and
connecting a second volume for a second cold gas to the cold gas outlet or the first volume.
